(19) United States
(12) Patent Application Publication
(10) Pub. No.: US 2021/0211462 A1
(43) Pub. Date: Jul. 8, 2021

(54) Malicious Email Mitigation

(71) Applicant: Bank of America Corporation, Charlotte, NC (US)

(72) Inventors: Christopher D. Birch, Tega Cay, SC (US); Carolyn D. Van Epps, Charlotte, NC (US); Nicholas Peach, Charlotte, NC (US)

(21) Appl. No.: 16/736,000

(22) Filed: Jan. 7, 2020

(51) Int. Cl. H04L 29/06; H04L 12/58

(52) U.S. Cl. CPC H04L 63/1483; H04L 51/08; H04L 63/1416; H04L 63/0236

(57) ABSTRACT

A malicious email mitigation process provides safe handling of emails and protects users from malicious content such as contained in phishing emails. A mail-delivery agent on a mail server receives an original email from a sender. The mail-delivery agent analyzes whether the sender is inside or outside of a safe zone and/or is a trusted sender. If the sender is inside the safe zone, the server transmits to the client the original email without alteration. If originating from an unsafe zone and/or from a potentially unsafe sender, the server deobfuscates any links in the original email, converts the original email into a sanitized communications file, and creates an image of the original email. The server transmits the sanitized communication file to a mailbox on the client along with the image copy of the original email as an attachment and any original attachments to the original email that are safe.

### TECHNICAL FIELD OF DISCLOSURE

The present disclosure relates to processes and machines for information security and, in particular, to monitoring or scanning of software or data to provide sanitized communication files that protect against attempted malware intrusions and historical malicious email vulnerabilities.

### BACKGROUND

More and more “computer machines” and “computer software and data” are communicating with one another via emails over “network(s).” Emails originating from within a company's network are likely safe and likely do not contain any malicious content. Conversely, it is common for hackers to send emails containing malicious content over the Internet to unsuspecting individuals inside a company in an effort to gain access to accounts and data controlled and/or accessible by the individual. A common example of this is what is known as phishing.

Phishing is the fraudulent attempt to obtain sensitive information such as usernames, passwords and credit card details by disguising oneself as a trustworthy entity in an electronic communication. Typically carried out by email spoofing, a phishing email directs users to enter personal information at a fake website which matches the look and feel of the legitimate site. This is often accomplished by the email purporting to be from trusted parties such as social web sites, auction sites, banks, online payment processors or IT administrators. A link provided in the email is named such that it appears to be from a trusted party; however, in reality, the link (e.g. malicious content) directs the user to the fake website where the user unsuspectingly provides his or her sensitive information.

Attempts to deal with phishing incidents include legislation, user training, public awareness, and technical security measures (the latter being due to phishing attacks frequently exploiting weaknesses in current web security). However, such prior art attempts at protecting users from phishing emails are insufficient and often fail to provide the needed protection.

The disclosure addresses one or more of the shortcomings in the industry, thus protecting users from emails containing malicious content.

### SUMMARY

In light of the foregoing background, the following presents a simplified summary of the present disclosure in order to provide a basic understanding of various aspects of the disclosure. This summary is not limiting with respect to the exemplary aspects of the inventions described herein and is not an extensive overview of the disclosure. It is not intended to identify key or critical elements of the disclosure or to delineate the scope of the disclosure. Instead, as would be understood by a personal of ordinary skill in the art, the following summary merely presents some concepts of the disclosure in a simplified form as a prelude to the more detailed description provided below.

As used throughout this disclosure, computer-executable “software and data” can include one or more: algorithms, applications (e.g., conversion, imaging, and scanning applications), attachments, emails, encryptions, databases, datasets, drivers, data structures, firmware, graphical user interfaces, images, instructions, IP addresses, machine learning, mail-delivery agents, middleware, modules, objects, operating systems, processes, protocols, programs, scripts, tools, and utilities. The computer-executable software and data is stored in tangible, non-volatile, computer-readable memory (locally or in network-attached storage) and can operate autonomously, on-demand, on a schedule, and/or spontaneously.

“Computer machines” can include one or more: general-purpose or special-purpose network-accessible personal computers, desktop computers, laptop or notebook computers, distributed systems, domain name systems, mail servers, workstations, portable electronic devices, smart devices, and/or servers having one or more microprocessors for executing or accessing the computer-executable software and data. Computer machines also includes all hardware and components typically contained therein. The “servers” can be virtual or physical, on-premise or remote, and can execute, access, and/or store the computer-executable software and data. The servers may be standalone or have distributed functionality and resources.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of any of the same. Networks also include associated “network equipment” such as access points, ethernet adaptors (physical and wireless), firewalls, hubs, modems, routers, and/or switches located inside the network and/or on its periphery, as well as software executing on any of the foregoing.

In a general aspect of the disclosure, a malicious email mitigation process for handling an original email sent by a sender to a client retrieves from a domain name system an IP address for a mail server corresponding to a domain name in the original email. A mail-delivery agent on the mail server receives the original email from the sender. The mail-delivery agent analyzes whether header information for the original email identifies the sender as being inside or outside of a safe zone, and/or compares information in the original email to one or more lists of trusted senders. If the sender is inside the safe zone and/or trusted, the mail-delivery agent transmits to a mailbox on the client, the original email without alteration. If the sender is outside the safe zone, unknown, and/or not trusted, the mail-delivery agent on the mail server deobfuscates any links in the original email. The mail-delivery agent on the mail server converts the original email into a sanitized communication file. The mail-delivery agent on the mail server creates an image copy of the original email. The mail-delivery agent on the mail server transmits to the mailbox on the client, the sanitized communication file with the image copy as an attachment.

In another general aspect of the disclosure, computer-executable software can implement a malicious email mitigation process for handling an original email sent by a sender to a client. The server receives the original email from the sender. The server determines whether the sender is inside or outside of a safe zone. For example, a safe zone may be set as anything within a company's secure network and an unsafe zone could be anything outside the company's secure network. As an example, emails received over the Internet could be considered to have been sent from an unsafe zone whereas emails originating from within the company's secure network could be considered a having originated from a safe zone. If the sender is inside the safe zone (e.g., the sender is a trusted sender and/or the email was sent from within the company's secure network), the server can provide the client with the original email without alteration. However, if the user was located outside the safe zone when the email was sent or, alternatively, if the email originated from outside the safe zone, or if the sender is unknown or not a trusted sender, the server could deobfuscate any links in the original email, convert the original email into a plain text email, and create a non-selectable and non-clickable safe image of the original email. The server can then provide the plain text email to the client and can attach to the plain text email the image copy of the original email as an attachment.

In another aspect of the invention, the server can further scan any attachment to the original email for malicious content including, but not limited to, viruses or masked links. If no malicious content is found, the server can provide the original attachments to the client as an attachment to the plain text email along with the image of the original email. If desired, the server can quarantine any attachment containing malicious content and can notify the client if any malicious content is detected.

In a further aspect of the invention, a malicious email mitigation machine for handling an original email sent by a sender over a network to a client can be used. The machine can include a server coupled to the network that contains a tangible, non-transitory computer-readable medium storing computer-executable instructions and a computer processor for executing said instructions stored thereon. Receiving instructions stored on the computer-readable memory can be used to receive the original email and store the original email in the computer-readable memory. Deobfuscating instructions stored on the computer-readable memory can be used to identify a URL for any link contained in the original email. Conversion instructions stored on the computer-readable memory can convert the original email into a plain text email. Imaging instructions stored on the computer-readable memory can create an image of the original email. Sending instructions stored on the computer-readable memory can send the plain text email and the image of the original email to the client.

In some aspects of the invention, some or all of the contents of the email image can be non-clickable and non-text-selectable for further safety.

In a further aspect of the invention, the malicious email mitigation machine can include attachment handling instructions stored on the computer-readable memory for providing any original attachment to the original email as an additional attachment to the plain text email.

In yet another aspect of the invention, scanning instructions stored on the computer-readable memory can scan any original attachment to the original email for malicious content. And, if any such content is detected, it can be removed, or the attachment can be quarantined. If desired, the client can be notified that malicious content was detected in the attachment as well as how the server handled the detection.

In yet another aspect of the invention, a malicious email mitigation application on a server can handle an original email sent by a sender to a client over a network. The server can receive an original email sent over a network from a sender. The server can determine whether the sender sent the original email over the Internet and/or if the sender is from a trusted list of users. If the sender did not send the original email over the Internet and/or if the sender is a trusted user, the server can provide the original email without alteration of it or its attachments to the client. If the sender sent the original email over the Internet and/or is not on a trusted list of users, the server can deobfuscate any links in the original email into non-clickable source text identifying the URL, convert the original email into a plain text email, create an image copy of the original email that is non-text-selectable and non-clickable; and scan any original attachment to the original email for any malicious content. If the original attachment did not contain any malicious content, the server can provide the client with the plain text email and attach thereto the image copy of the original email and the original attachment. If the original attachment contains any malicious content, the server can quarantine any attachment containing the malicious content and only provide to the client the plain text email with the image copy of the original as well as any safe attachments. If scanning detected any malicious content in any of the original attachments, the server can notify the client as to which attachments contained malicious content and were quarantined.

Implementations of various aspects of this disclosure can vary depending on the preferences of system engineers and programs, all of which would be within the knowledge of a person of ordinary skill in the art and could be implemented by such a person without undue experimentation by using custom and/or commercially available software. Although specific examples have been suggested for certain aspects of the disclosure, other implementations can be substituted without departing from the spirit of the invention contained in this disclosure and all are considered within the scope of the invention and claims.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a schematic diagram of a digital computing environment in which certain aspects of the present disclosure may be implemented.

FIG. 2 depicts a sample phishing email.

FIG. 3 is an illustrative flowchart of a method performed in accordance with one or more implementations to safely mitigate emails potentially having malicious content.

FIG. 4 depicts a sample email that has been converted to plain text and in which a malicious URL has been deobfuscated.

FIG. 5 depicts a non-clickable and non-text-selectable image of the phishing email that it can be safely viewed by a user.

FIG. 6 illustrates exemplary computer-readable memory storing various computer software and data used in accordance with aspects of the disclosure.

### DETAILED DESCRIPTION

In the following description of the various embodiments to accomplish the foregoing, reference is made to the accompanying drawings, which form a part hereof, and in which is shown by way of illustration, various embodiments in which the disclosure may be practiced. It is to be understood that other embodiments may be utilized, and structural and functional modifications may be made.

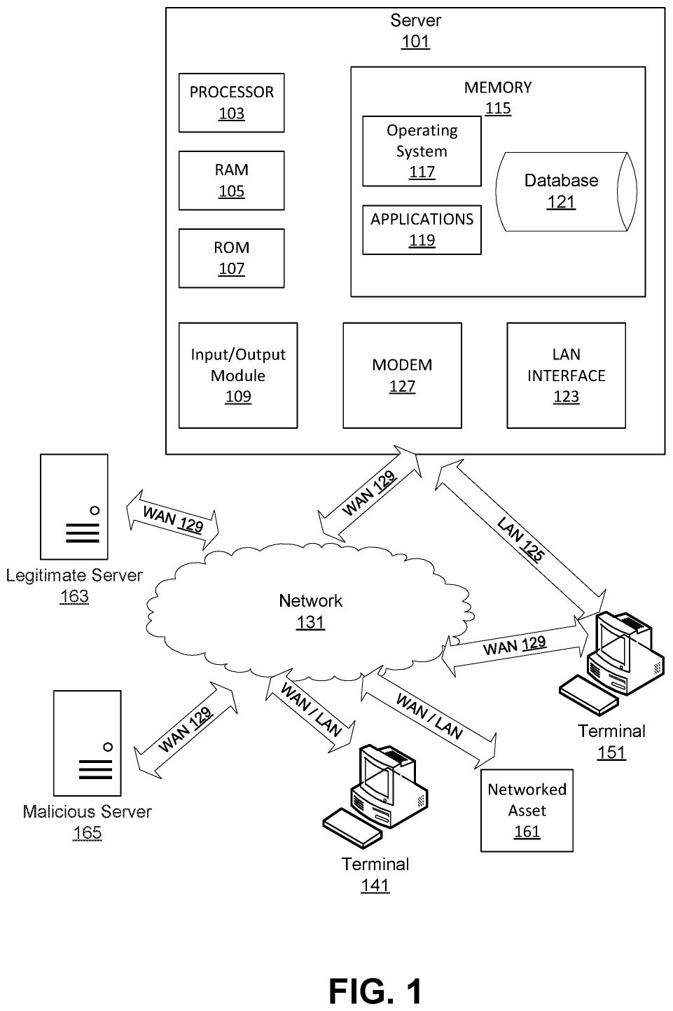

FIG. 1 illustrates a system block diagram of a specific programmed computer machine 101 (e.g., a server) that may be used according to an illustrative embodiment of the disclosure. A server 101 may have a processor 103 for controlling overall operation of the server and its associated components, including RAM 105, ROM 107, input/output module 109, and memory 115.

Input/Output (I/O) 109 may include a microphone, keypad, touch screen, camera, and/or stylus through which a user of device 101 may provide input, and may also include one or more of a speaker for providing audio output and a video display device for providing textual, audiovisual and/or graphical output. Other I/O devices through which a user and/or other device may provide input to device 101 also may be included. Software may be stored within memory 115 and/or storage to provide computer readable instructions to processor 103 for enabling server 101 to perform various technologic functions and to access data. For example, memory 115 may store software used by the server 101, such as an operating system 117, application programs 119, and an associated database 121. Some or all of server 101 computer-executable instructions may be embodied in hardware or firmware (not shown).

The server 101 may operate in a networked environment supporting connections to one or more remote computers, such as terminals 141 and 151 and networked asset 161. The terminals 141 and 151 may be personal computers or servers that include many or all of the elements described above relative to the server 101. The networked asset 161 may be similar to terminals 141 and 151, or may be a database server device, an application server device, a web server device, a firewall device, or any other computerized asset electrically connected to the network 131. In one example, networked asset 161 may be a software application operating on a terminal device 151; the software application may be a smartphone application or may be a web browser-based application. Computing device 101, terminals 141 or 151, and/or networked asset 161 may also be mobile terminals including various other components, such as a battery, speaker, and antennas (not shown).

The network connections depicted in FIG. 1 include LAN(s) and WAN(s), such as 125 and 129, but may also include other networks. When used in a LAN networking environment, a computer such as 101 is connected to the LAN 125 through a network interface or adapter 123. When used in a WAN networking environment, the server 101 may include a modem 127 or other means for establishing communications over the WAN 129, such as the network 131 (e.g., Internet). The server 101 may also use a LAN interface 123 to access a WAN or the Internet. It will be appreciated that the network connections shown are illustrative and other means of establishing a communications link between the computers may be used. Connections from any of the computers and network assets can be either via LAN(s), WAN(s), and/or a combination thereof. The existence of any of various protocols such as TCP/IP, Ethernet, FTP, HTTP and the like is presumed.

For illustration purposes, FIG. 1 also shows a sample malicious server 165 and legitimate server 163 coupled to the network 131 via either LAN(s) and/or WAN(s). In addition, mail server 167 and domain name system 169 are shown, and can either be integrated into server 101 and associated memory or separate. The present invention can be implemented in a single machine or across multiple machines with distributed functionality.

The disclosure is operational with numerous other general-purpose or special-purpose computing system environments, configurations, machines, and processes, as broadly and non-exhaustively defined in the summary of the invention with respect to computer-executable software and data, computer machines, and networks.

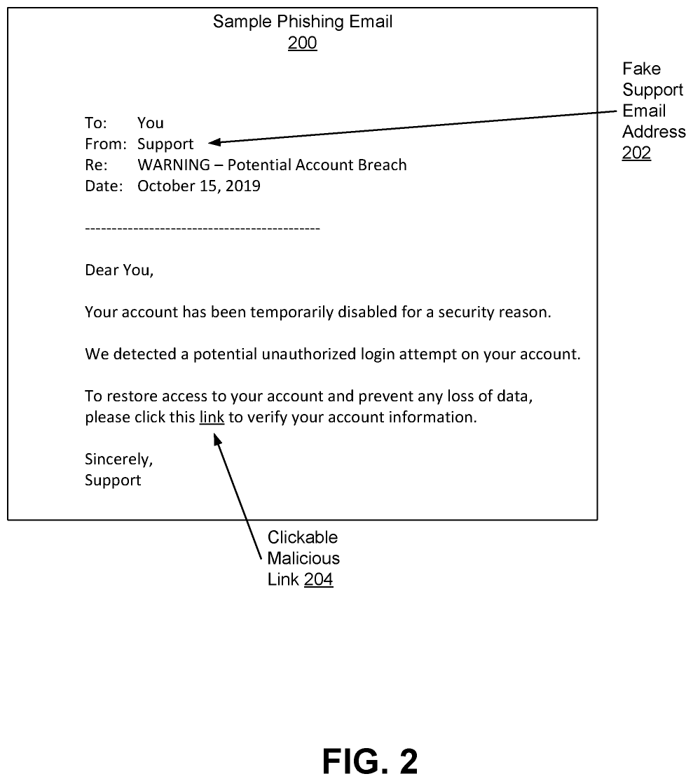

Referring to FIG. 2, a sample phishing email 200 is shown. The email is a form of spoofing. The mail purports to be from a trusted party such as, for example, customer “support” email address from a legitimate company with whom the user has an account. However, the email address is actually a fake address 202 that appears legitimate. The email 200 contains text that tries to fool the user into believing that the user's account has been temporarily disabled for a security reason such as, for example, because a potential unauthorized login allegedly was attempted on the user's account. The email 200 then instructs the user to click on link 204 to go to a page to have the user access his account in order to allegedly prevent the loss of data. The link 204 will appear to point to the legitimate company's website; however, in reality, it is actually a URL pointing to the criminal's website which, when accessed, will appear to be legitimate but, in reality, is actually a fake website whose sole purpose is to trick the user into revealing his confidential information such as login credentials to the criminal.

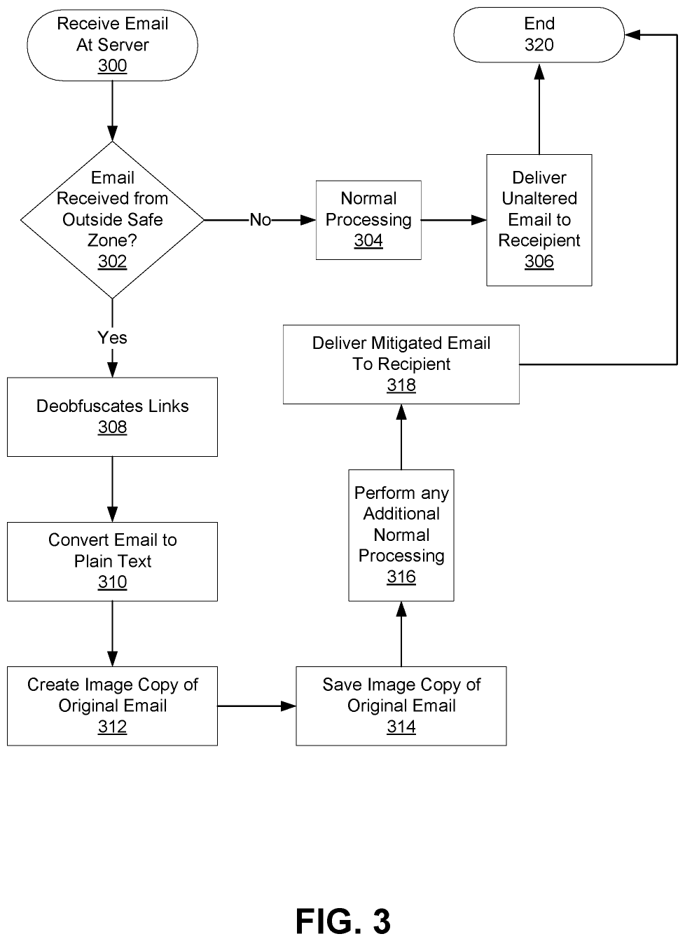

In order to protect the user from the phishing email, a malicious email mitigation process such as shown in the flow chart of FIG. 3 can be used.

A server can receive 300 an email from a sender. In step 300, the server can determine if the email was sent from a trusted sender and/or if the email was sent from inside a safe zone such as, for example, within a secure company network. If the email is safe (i.e., was sent by a trusted sender and/or was sent from within a trusted zone), the server can perform normal processing 304 on the email and its attachments such as, for example, by performing virus scanning of the email and attachments, and if safe, can be provided to the intended email recipient without alteration or quarantine 306.

However, if the sender was not a trusted sender and/or the sender did not send the email from within a trusted zone, the system can proceed to process the email for safe handling. In step 308, any links contained in the email can be deobfuscated. In addition, the sender email address and/or header information may be deobfuscated and/or unmasked as well. This will reveal in plain text the true URL to which the link 204 actually points and/or unmask the actual or purported email address as well as header information if desired. The server can then convert the original email into a sanitized communication file such as plain text email which could be completely plain text without any formatting or graphics, or could contain only safe formatting and/or safe graphics.

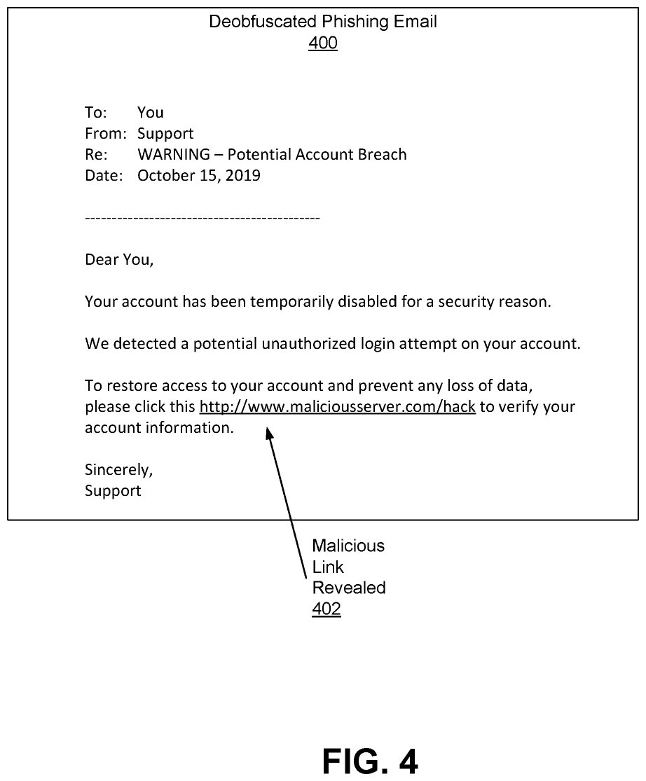

An example of this is shown in FIG. 4. As can be seen based on a comparison of FIG. 2 to FIG. 4, the true identity of the malicious link 204 has been revealed in the deobfuscated plain text email to identify the criminal website which, in this example, is http://www.malicousserver.com/hack 402. And, the remainder of the email is shown in plain text 400.

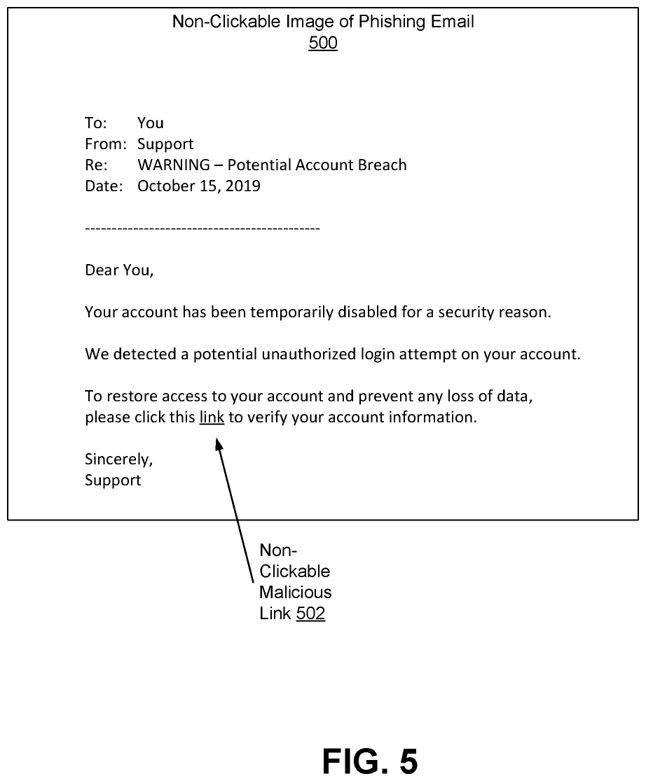

In order to preserve all of the original formatting and graphics for the user to safely view, an image of the original email can be created in step 312, like shown in FIG. 5, where the link has become non-selectable and/or non-clickable 502. Persons of skill in the art will recognize than any traditional technique of creating an image can be used. The image can be saved to computer-readable memory 314.

The server can perform any additional normal processing 316 on the email and its attachments such as, for example, by performing virus scanning of the email and attachments such as in step 304.

The plain text email, the image of the original email, and any safe attachments to the original email, can then be delivered to the intended recipient in step 318.

If any attachment has been determined to be unsafe, the attachment can be quarantined (not shown). And, the unsafe attachment is not provided by the server to the client. If desired, the client can be notified by the server if any attachment was quarantined and/or if malicious content contained therein was identified.

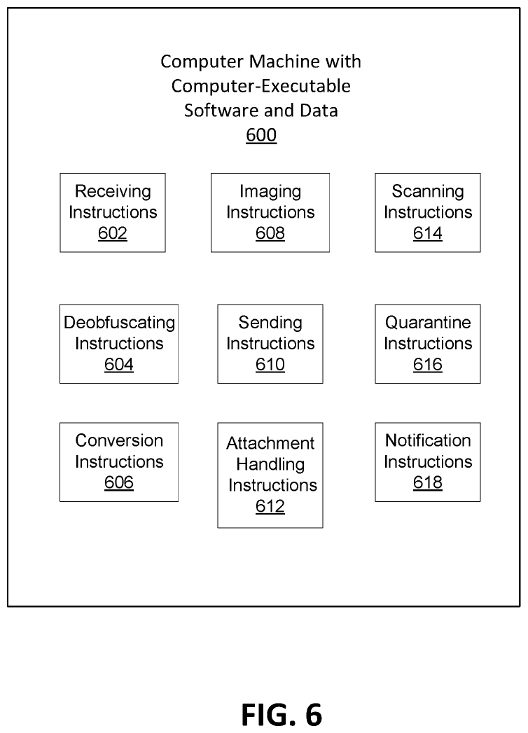

FIG. 6 illustrates exemplary computer-readable memory 500 for one or more malicious email mitigation machines with integrated or distributed functionality, one or more of which store various computer software and data used in accordance with aspects of the disclosure. This includes receiving instructions 602 stored on the computer-readable memory used to receive the original email and store the original email in the computer-readable memory. Deobfuscating instructions 604 stored on the computer-readable memory can be used to identify a URL for any link contained in the original email. Conversion instructions 606 stored on the computer-readable memory can convert the original email into a plain text email. Imaging instructions 608 stored on the computer-readable memory can create an image of the original email. Sending instructions 610 stored on the computer-readable memory can send the plain text email and the image of the original email to the client. Attachment handling instructions 612 stored on the computer-readable memory for can provide any original attachment to the original email as an additional attachment to the plain text email. Scanning instructions 614 stored on the computer-readable memory can scan any original attachment to the original email for malicious content. And, if any such content is detected, it can be removed, or the attachment can be quarantined by quarantine instructions 616. If desired, the client can be notified that malicious content was detected in the attachment as well as how the server handled the detection by notification instructions 618.

Sanitized file instructions 622 stored on the computer-readable medium can clean the original email of malicious content and/or unmask it for review. The sanitized file itself 624 is stored on the computer-readable medium along with the original email file 626. If desired, the original email file may be stored in a quarantined area of memory until determined to be safe. A mail-delivery agent 628 on the computer-readable medium functions to receive and process emails received by the mail server or other computer. A mailbox 630 in computer-readable memory on a client computer handles emails and notifications received by the client using a POP3/IMAP or other protocol as well as outgoing communications using an SMTP or other protocol. An IP address module 632 handles the storage of IP addresses and works in conjunction with a local or remote domain name system module 634 to look up IP addresses and determine whether the original email originated from a trusted zone or an unsafe zone. A module or database 636 of trusted zones and/or trusted senders is also store on the computer-readable medium and can be accessed by the mail-delivery agent.

The foregoing instructions, modules, and/or databases are executable or accessed by microprocessors in one or more computer machines, which can be integrated and/or distributed as well as local and/or remote.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1) A malicious email mitigation process for handling an original email sent by a sender to a client comprising the steps of:
a) retrieving from a domain name system an IP address for a mail server corresponding to a domain name in the original email;
b) receiving, by a mail-delivery agent on the mail server, the original email from the sender;
c) analyzing, by the mail-delivery agent, whether header information for the original email identifies the sender as being inside or outside of a safe zone based on the IP address for the mail server retrieved from the domain name system;
d) if the sender is inside the safe zone:
i) transmitting, by the mail-delivery agent to a mailbox on the client, the original email without alteration; and
e) if the sender is outside the safe zone:
i) deobfuscating, by the mail-delivery agent on the mail server, any links in the original email;
ii) converting, by the mail-delivery agent on the mail server, the original email into a sanitized communication file;
iii) imaging, by the mail-delivery agent on the mail server, the original email to create an image copy of the original email; and
iv) transmitting, by the mail-delivery agent on the mail server to the mailbox on the client, the sanitized communication file with the image copy as an attachment.

2) The malicious email mitigation process of claim 1 wherein analyzing whether the sender is inside or outside the safe zone is based on whether the sender is inside a local network.

3) The malicious email mitigation process of claim 1 wherein analyzing whether the sender is inside or outside the safe zone is based on whether the original email was received from the Internet.

4) The malicious email mitigation process of claim 1 wherein analyzing whether the sender is inside or outside the safe zone is based on: retrieving from a database a dataset of trusted senders and comparing the sender of the original email to the dataset of trusted senders.

5) The malicious email mitigation process of claim 3 further comprising the step of transmitting, by the mail-delivery agent on the server to the mailbox on the client, any original attachment to the original email as an additional attachment to the plain text email.

6) The malicious email mitigation process of claim 3 further comprising the steps of:
a) scanning, by the server, any original attachment to the original email for any malicious content and,
b) if no malicious content is identified, attaching the original attachment as an additional attachment to the sanitized communication file.

7) The malicious email mitigation process of claim 6 further comprising the step of quarantining the original attachment if any said malicious content was detected.

8) The malicious email mitigation process of claim 6 wherein the client is notified by the mail-delivery agent on the server if any said original attachment contains any said malicious content.

9) The malicious email mitigation process of claim 7 wherein the client is notified if any said original attachment contains the original attachment was quarantined.

10) A malicious email mitigation machine for handling an original email sent by a sender over a network to a client comprising:
a) a mail server coupled to the network that contains a tangible, non-transitory computer-readable medium storing computer-executable instructions and a computer processor for executing said instructions stored thereon;
b) mail-delivery-agent receiving instructions stored on the computer-readable memory to receive the original email and store the original email in a quarantined section of the computer-readable memory;
c) deobfuscating instructions stored on the computer-readable memory to identify a URL for any link contained in the original email stored in the quarantined memory;
d) conversion instructions stored on the computer-readable memory to convert the original email into a sanitized communication file;
e) imaging instructions stored on the computer-readable memory to create an image of the original email; and
f) mail-delivery-agent transmitting instructions stored on the computer-readable memory to send the sanitized communication file and the image of the original email to a mailbox on the client.

11) The malicious email mitigation machine of claim 19 wherein the image of the original email is non-clickable and non-text-selectable.

12) The malicious email mitigation machine of claim 11 further comprising attachment handling instructions stored on the computer-readable memory for providing any original attachment to the original email as an additional attachment to the sanitized communication file.

13) The malicious email mitigation machine of claim 11 further comprising scanning instructions stored on the computer-readable memory for scanning any original attachment to the original email for malicious content.

14) The malicious email mitigation machine of claim 13 wherein the mail-delivery-agent transmitting instructions send sanitized communication file, the image of the original email, and any said original attachment to the original email to the mailbox on the client if no said malicious content was detected.

15) The malicious email mitigation machine of claim 14 further comprising notification instructions stored on the computer-readable memory to notify the client if any said original attachment contained any said malicious content.

16) The malicious email mitigation machine of claim 14 further comprising quarantine instructions stored on the computer-readable memory to quarantine any said original attachment containing any said malicious content.

17) The malicious email mitigation machine of claim 11 wherein the deobfuscating instructions translate any said link into non-clickable source text identifying the URL.

18) The malicious email mitigation machine of claim 14 wherein the deobfuscating instructions translate any said link into non-clickable source text identifying the URL.

19) The malicious email mitigation machine of claim 15 wherein the deobfuscating instructions translate any said link into non-clickable source text identifying the URL.

20) A malicious email mitigation method, executed on a server for handling an original email sent by a sender to a client over a network comprising the steps of:
a) receiving, by a mail-delivery agent on the server over the network, the original email from the sender;
b) analyzing header information extracted from the original email, by the mail-delivery agent on the server, to determine whether the sender sent the original email over the Internet;
c) if the sender did not send the original email over the Internet:
i) transmitting, by the mail-delivery agent on the server to a mailbox on the client, the original email without alteration; and
d) if the sender sent the original email over the Internet:
i) deobfuscating, by the mail-delivery agent on the server, any links in the original email into non-clickable source text identifying the URL;
ii) converting, by the mail-delivery agent on the server, the original email into a sanitized communication file;
iii) imaging, by the mail-delivery agent on the server, the original email to create an image copy of the original email that is non-text-selectable and non-clickable;
iv) scanning, by the mail-delivery agent on the server, any original attachment to the original email for any malicious content; and
v) if the original attachment did not contain any said malicious content:
(1) transmitting, by the mail-delivery agent on the server to the mailbox on the client, the sanitized communication file and attaching thereto the image copy of the original email and the original attachment; and
vi) if the original attachment contains any said malicious content:
(1) quarantining, by the mail-delivery agent on the server, any said original attachment containing any malicious content; and
(2) transmitting, by the mail-delivery agent on the server to the mailbox on the client, the sanitized communication file with the image copy of the original and a notification that the original attachment contained said malicious content and was quarantined.
